(19) United States
(12) Patent Application Publication
(10) Pub. No.: US 2013/0047440 A1
(43) Pub. Date: Feb. 28, 2013

(54) SCISSOR DESIGN HAVING FINGER HOLE

(71) Applicant: KEITH BARTON, Woodland, CA (US)

(72) Inventor: KEITH BARTON, Woodland, CA (US)

(21) Appl. No.: 13/215,142

(22) Filed: Aug. 22, 2011

(51) Int. Cl. B26B 13/20

(52) U.S. Cl. 30/232

(57) ABSTRACT

A scissor has a finger hole mechanism mounted on the side of one of the scissor handles. The finger hole mechanism may allow the scissor to be worn, rather than gripped. When the scissor is not in use, the scissor remains on the finger—yet allows the use of all fingers for other tasks. To resume use, only the thumb is needed to press the scissor closed—as it no longer needs to be held, merely used when needed.

### BACKGROUND OF THE INVENTION

The present invention relates to scissors and, more particularly, to scissors having a single finger hole.

When using scissors, a user may need to use the hand or fingers that were operating the scissors. This often requires the user to put the scissors down, perform the task, and pick the scissors back up. This may be problematic in some situations. For example, in the medical profession, there may not be a sterile surface to rest the scissors if the practitioner needs to place the scissors down during use. In fly fishing, scissors may be used in fly tying, however, it may be inconvenient to keep picking up and putting down scissors.

Referring to FIG. 3, a conventional spring-opening scissor 100 may include cutting blades 118 that hinge on a central pivot to form the cutting edge of the scissor 100. The blades 118 may attach to scissor arms 114, 116 at one end thereof. At the opposite end, the scissor arms 114, 116 may end in spring steel clips 112 that attach together at the rear of the scissor 100. The spring steel clips 112 may provide resistance to closure of the scissor 100. A grip 122 may be provided to help retain the scissor 100 in the user's hand.

As can be seen, there is a need for scissors that may be kept in the user's hand while leaving the user's finger free.

### SUMMARY OF THE INVENTION

In one aspect of the present invention, a tool comprises a first handle; a second handle pivotably attached to the first handle; blades at a first end of the first and second handles, the blades adapted to form a cutting edge when the first and second handles are pivoted; and a finger hole mechanism attached at a central location along a length of the first handle.

In another aspect of the present invention, a scissor comprises a first handle; a second handle pivotably attached to the first handle; blades at a first end of the first and second handles, the blades adapted to form a cutting edge when, the first and second handles are pivoted; a finger hole mechanism attached to the first handle; and a spring mechanism at a second end of the first and second handles, the spring mechanism adapted to resiliently keep the blades in an open position.

In a further aspect of the present invention, a scissor comprises a first handle; a second handle pivotably attached to the first handle; blades at a first end of the first and second handles, the blades adapted to form a cutting edge when the first and second handles are pivoted; a finger hole mechanism attached at a central location along a length of the first handle; and a spring mechanism at a second end of the first and second handles, the spring mechanism adapted to resiliently keep the blades in an open position, wherein the spring mechanism is formed from spring steel integrally formed with the second end of the first and second handles.

These and other features, aspects and advantages of the present invention will become better understood with reference to the following drawings, description and claims.

### BRIEF DESCRIPTION OF THE DRAWINGS

FIG. 1 is a perspective view of scissors according to an exemplary embodiment of the present invention;

FIG. 2 is a side view of the scissors of FIG. 1; and

FIG. 3 is a perspective view of scissors according to the prior art.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, an embodiment of the present invention provides a scissor having a finger hole mechanism mounted on the side of one of the scissor handles. The finger hole mechanism may allow the scissor to be worn, rather than gripped. When the scissor is not in use, the scissor remains on the finger—yet allows the use of all fingers for other tasks. To resume use, only the thumb is needed to press the scissor closed—as it no longer needs to be held, merely used when needed.

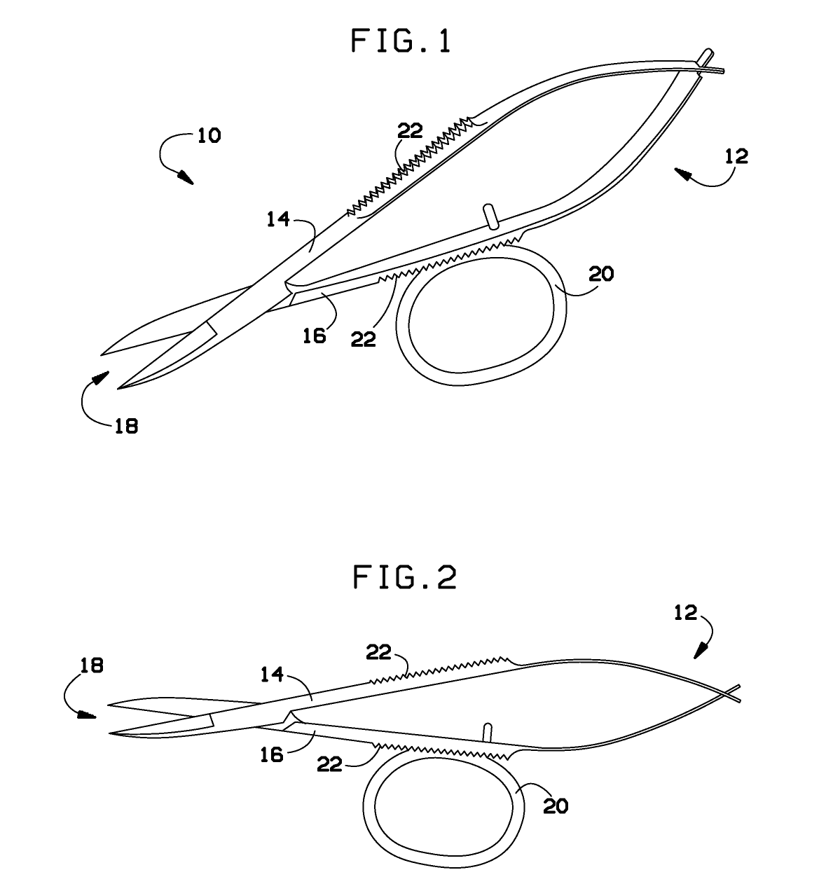

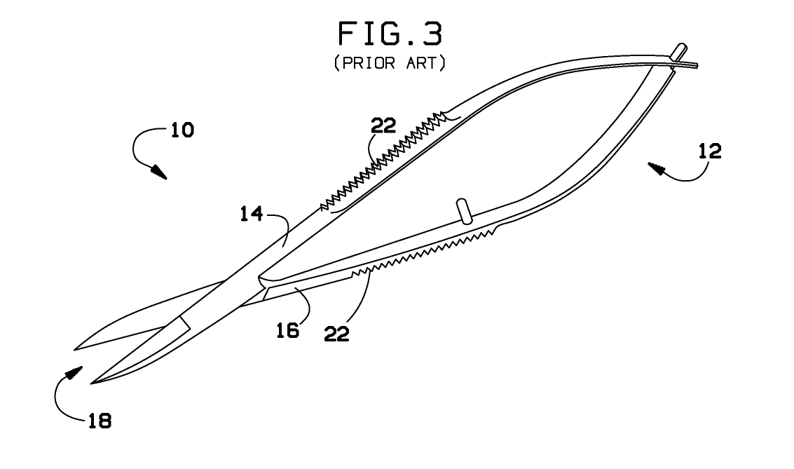

Referring to FIGS. 1 and 2, a scissor 10 may be formed be scissor handles 14, 16 having cutting blades 18 at one end thereof. The handles 14, 16 may pivot to provide a cutting action when an object is placed between the blades 18. At an opposite end of the handles 14, 16, a spring steel clips may attach together to form a spring mechanism 12. This spring mechanism 12 may be used to keep the scissor 10 in an open position as shown in FIG. 1. When a user wishes to cut an item, the user may squeeze the handles 14, 16 together, for example, at grips 22, to close the blades 18. The spring mechanism 12 may re-open the blades 18 when the user ceases to squeeze the handles 14, 16 together.

A finger hole mechanism 20 may be attached to one of the handles 14, 16. The finger hole mechanism 20 may allow the scissor 10 to be worn, rather than gripped. When the scissor is not in use, the scissor remains on the finger—yet allows the use of all fingers for other tasks.

The scissor 10 of the present invention may be made from conventional materials, for example, stainless steel. The scissor 10 may be cast in the proper form using molten metal, or they may be pounded or ground to shape using metal working machinery.

While the Figures show the finger hole mechanism 20 disposed near a central location along the length of the handle 16, the finger hole mechanism 20 may be disposed at various locations along the length of the handle 16. For example, for applications where additional squeezing force may be needed, the finger hole mechanism 20 may be disposed closer to the spring mechanism 12. The finger hole mechanism 20 may be sized to fit on a person's finger. Various inside diameters of the finger hole mechanism 20 may be provided to fit various-sized fingers.

The scissor of the present invention may be used in any application where conventional scissors are used. For example, the scissor of the present invention may be used by medical professionals and may be reused on a patient many times without the need to set the scissor down on a non-sterile surface between uses. In other embodiments, the scissor of the present invention may be used to aid in tying fishing flies. The scissor allows the person tying flies to keep the scissors in his hand while using his fingers to complete other steps, before the scissors are needed again. This speeds work measurably, because the scissors are in the user's hand permanently, rather than having to look for them between uses. In still other embodiments, the scissor may be used in various textile industries.

It should be understood, of course, that the foregoing relates to exemplary embodiments of the invention and that modifications may be made without departing from the spirit and scope of the invention as set forth in the following claims.

What is claimed is:

1. A tool comprising:
a first handle;
a second handle pivotably attached to the first handle;
blades at a first end of the first and second handles, the blades adapted to form a cutting edge when the first and second handles are pivoted; and
a finger hole mechanism attached at a central location along a length of the first handle.

2. The tool of claim 1, further comprising a grip disposed on at least one of the first and second handles.

3. The tool of claim 1, further comprising a spring mechanism at a second end of the first and second handles, the spring mechanism adapted to resiliently keep the blades in an open position.

4. The tool of claim 3, wherein the spring mechanism is formed from spring steel integrally formed with the second end of the first and second handles.

5. A scissor comprising:
a first handle;
a second handle pivotably attached to the first handle;
blades at a first end of the first and second handles, the blades adapted to form a cutting edge when the first and second handles are pivoted;
a finger hole mechanism attached to the first handle; and
a spring mechanism at a second end of the first and second handles, the spring mechanism adapted to resiliently keep the blades in an open position.

6. The scissor of claim 5, wherein the finger hole mechanism is formed at a central location along a length of the first handle.

7. The scissor of claim 5, further comprising a grip disposed on at least one of the first and second handles.

8. The scissor of claim 6, wherein the spring mechanism is formed from spring steel integrally formed with the second end of the first and second handles.

9. A scissor comprising:
a first handle;
a second handle pivotably attached to the first handle;
blades at a first end of the first and second handles, the blades adapted to form a cutting edge when the first and second handles are pivoted;
a finger hole mechanism attached at a central location along a length of the first handle; and
a spring mechanism at a second end of the first and second handles, the spring mechanism adapted to resiliently keep the blades in an open position, wherein the spring mechanism is formed from spring steel integrally formed with the second end of the first and second handles.

10. The scissor of claim 9, further comprising a grip disposed on at least one of the first and second handles.
